(19) United States
(12) Patent Application Publication
(10) Pub. No.: US 2008/0245664 A1
(43) Pub. Date: Oct. 9, 2008

(54) Biosensor test strips for multiple tests

(76) Inventor: Yu-Hong Chang, San-Chung City (TW)

Correspondence Address: TROXELL LAW OFFICE PLLC, SUITE 1404, 5205 LEESBURG PIKE, FALLS CHURCH, VA, 22041, US

(21) Appl. No.: 11/984,827

(22) Filed: Nov. 21, 2007

Related U.S. Application Data
(63) Continuation-in-part of application No. 10/704,701, filed on Nov. 12, 2003, now abandoned.

(51) Int. Cl. G01N 27/26

(52) U.S. Cl. 204/403.03

(57) ABSTRACT

This invention discloses a detachable test strip good for multiple tests on a test strip to reduce the per test cost, and a test strip for multiple tests with more than two conductive tracks for the simultaneous measurement of multiple test data with a drop of blood.

### RELATED APPLICATION

This application is a Continuation-In-Part of currently pending U.S. patent application Ser. No. 10/704,701 filed on Nov. 12, 2003.

### BACKGROUND OF THE INVENTION

(a) Field of the Invention

The present invention generally relates to a biosensor test strip and, more particularly, to a test strip for the measurement of blood glucose, uric acid and cholesterol, etc., which have cost and functional advantages over the current devices.

(b) Discussion of the Prior Art

All the currently available biosensor test strips, whether they are for the measurement of blood glucose, uric acid, or cholesterol, use one strip to perform one test, which are often very expensive for the poor, especially in the developing countries, who can't afford to pay for the DIY (Do It Yourself) tests at home. Furthermore, all current test strips can only give one test result from one test strip. To simultaneously measure several different types of analytes in blood requires separate tests and several blood inoculations which are very painful for the patients. Davies (US2003/0024,811) disclosed a test strip with several detachable test pieces. However, it is important to note that in Davies's design ('811) every test piece to be broken off is an independent and complete test strip connected to the other test strips in series. In comparison, the test strip of the present invention share part of the same electrode, to save costs, and connected to the other test strips in parallel. It follows that, after each test, Davies' design ('811) breaks off a complete test strip, but our design only breaks off the reaction zone, which is only part of a complete test strip. Khan (U.S. Pat. No. 6,855,243) also disclosed a test strip with several detachable test pieces. Nevertheless, the test strip disclosed by Khan ('243) comprises a working electrode on one layer of the test strip with another reference electrode on the other layer of the test strip, but opposing each other, instead of the coplanar design of the conductive tracks of the present invention. Furthermore, Zhang (U.S. Pat. No. 6,670,115) disclosed a test strip with more than two conductive electrodes for simultaneous measurement of multiple biological tests. But, the test strip of the design proposed by Zhang ('115) is good for one time use only, unlike the design of the present invention which allows multiple tests on one single test strip, and further test is possible by breaking off the used reaction chamber to expose another reaction chamber ready for further tests. Wohlstadter (U.S. Pat. No. 6,673,533), Miyashita (US2004/0040866), Matzinger (U.S. Pat. No. 6,558,528) and Heller (U.S. Pat. No. 5,972,199) also disclosed multi-array biosensors. Regretfully, all test strips of their designs are independent and complete test strips, unlike our design. So far, there has been no such device to greatly reduce the cost of tests by offering multiple tests on a single test strip, nor any patent disclosed regarding this issue. It is therefore the objective of the present invention to disclose a different design of test strips, which can give more than one test results on a test strip from a drop of blood and to disclose a test strip for multiple tests on a test strip to reduce cost of every individual test.

### SUMMARY OF THE INVENTION

To develop a cheaper and more affordable biosensor test strip and a test strip capable of simultaneously performing more than one type of tests with a drop of blood, we hereby disclose a detachable test strip, which has a plurality of test reagents on a single test strip and which can be used for more than once on the same test strip. The most unique feature of the present invention is that after one test, the tested reaction chamber (or reaction zone) of the test strip can be broken off and the other un-tested reaction chambers with reagents can be well kept in the dry vial for further use. It is another preferred embodiment of the present invention to disclose a test strip that allows the simultaneous determination of several different biological analytes with a drop of blood.

### BRIEF DESCRIPTION OF THE DRAWINGS

The disposable and detachable test strips of the present invention may be more readily understood by one skilled in the art with reference to the following detailed description taken in conjunction with the accompanying drawings wherein like elements are designated by identical reference numbers throughout the several views and in which:

FIG. 1 is the schematic view of a detachable test strip with two conductive tracks for multiple tests, giving one test data per test.

FIG. 2 is the side view of the detachable test strip of FIG. 1 on which lays a plurality of reagents.

FIG. 3 illustrates the schematic view of the detachable test strip with three conductive tracks for multiple tests, giving two simultaneous test data per test with a drop of blood.

FIG. 4 illustrates the schematic view of the detachable test strip with four conductive tracks for multiple tests, giving two simultaneous test data per test with a drop of blood.

FIG. 5 gives the schematic view of the detachable test strips with four conductive tracks for multiple tests, giving three simultaneous test data per test with a drop of blood.

FIG. 6 gives the schematic view of the detachable test strips with six conductive tracks for multiple tests, giving three simultaneous test data per test with a drop of blood.

FIGS. 7A, 7B and 7C further indicate another type of detachable test strips for multiple tests on a test strip and for simultaneous measurement of multiple test data with a drop of blood.

### DETAILED DESCRIPTION OF THE PREFERRED EMBODIMENT

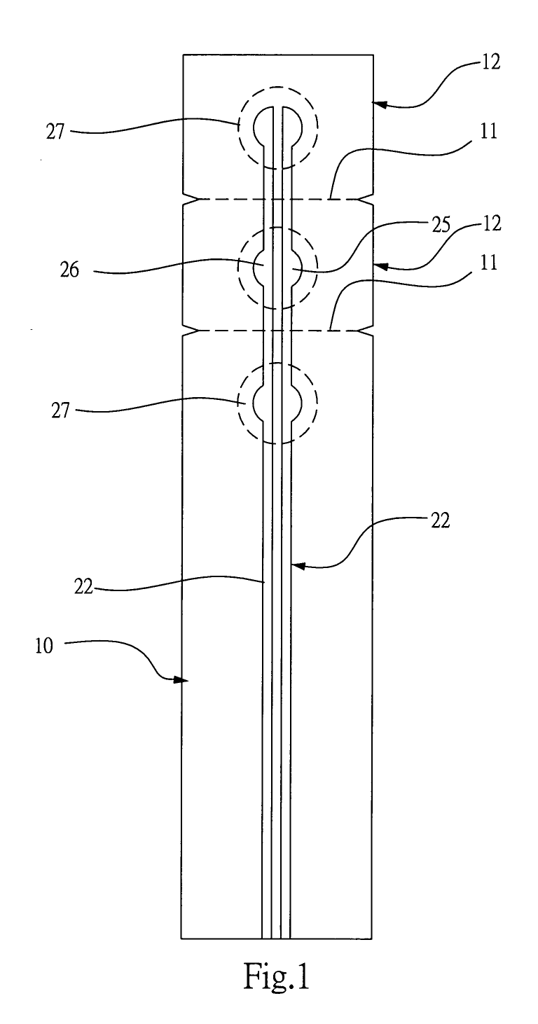

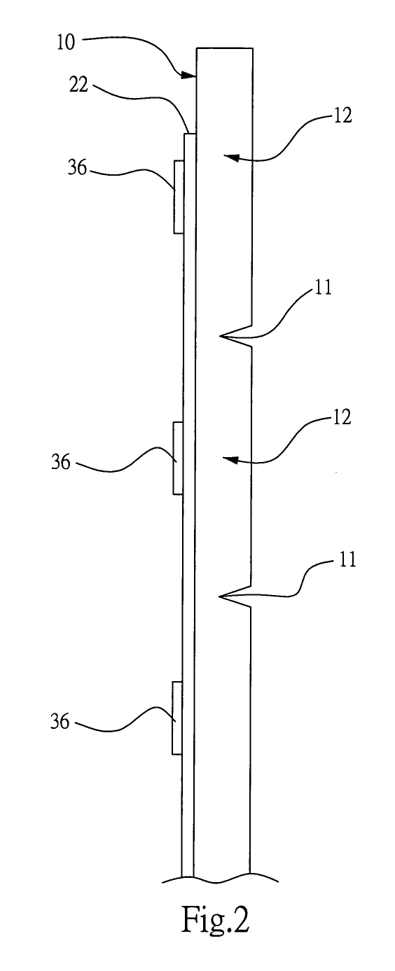

Referring to the drawings in detail, FIG. 1 is a schematic view of the detachable test strip for multiple tests which gives a test result per test. In FIG. 1, a pair of conductive tracks 22 sit on the base plate 10, which can be ordinary plastics such as Mylar, PVC (polyvinyl chloride), FRP (fiberglass reinforced plastics), paper, or ceramics, etc. The conductive tracks 22 may be, but not limited to, copper, silver, carbon, gold, platinum, conductive polymer, or other conductive materials such as carbon on silver, carbon on copper, carbon on gold, or carbon on platinum, etc. Along one of the conductive tracks 22 there are three working electrodes 25, and along the other conductive track 22 there are three reference electrodes 26. The working electrode 25 and reference electrode 26 may also be, but not limited to, carbon on copper, silver, carbon, gold, platinum, conductive polymer, or other conductive materials. The working electrode 25 and reference electrode 26 form a reaction zone (or reaction chamber) 27. The reagents 36, which contains glucose oxidase and mediator, thus apply over the reaction zones 27, as shown in FIG. 2. There are three reaction zones 27 on the base plate 10 to apply reagent 36. Between the three reaction zones 27, there are two incisions 11, across the underneath surface of the base plate 10 and on both sides of the base plate 10 to help easily break off the used section 12 which contains the reaction zone 27. Although FIG. 1 shows a test strip with 3 reaction zones 27, however, the design of the present invention is not limited to three reaction zones 27, but preferably two or over two reaction zones 27. As a reagent 36 is applied onto the reaction zone 27, the electrochemical response, which is proportional to the concentration of the analyte in blood can be measured from the conductive tracks 22. After a test on one of the section 12 along the conductive tracks 22 is done, the used section 12 containing the reaction zone (or reaction chamber) 27 is no longer useful and, therefore, the section 12 of the base plate 10, containing the used reaction zone 27 can be easily broken off from the incision 11.

FIG. 2 further gives the side view of the base plate 10 and conductive tracks 22, on top of which lay a reagent 36. The reagent 36 is placed over the reaction zones 27, not shown, across both the working electrode 25 and the reference electrode 26. The base plate 10, on which lays a pair of conductive tracks 22, may be covered with a spacer plate, with multiple recesses, as well be discussed later in more detail, to accommodate reaction zones for reagents 36, and on top of which may be covered with another top plate so that blood can be sucked into the said reaction zones in the recesses to react with the reagents therein. Pressure sensitive tapes or hot melt glue, not shown, are used to adhere the base plates with the spacer and top plates. The pressure sensitive tapes or hot melt glue used are so configured to leave multiple air venting passages between the spacer layer and the base plates to avoid air pressure buildup as the blood or body fluid is sucked into the recess through capillary forces to react with the reagents therein.

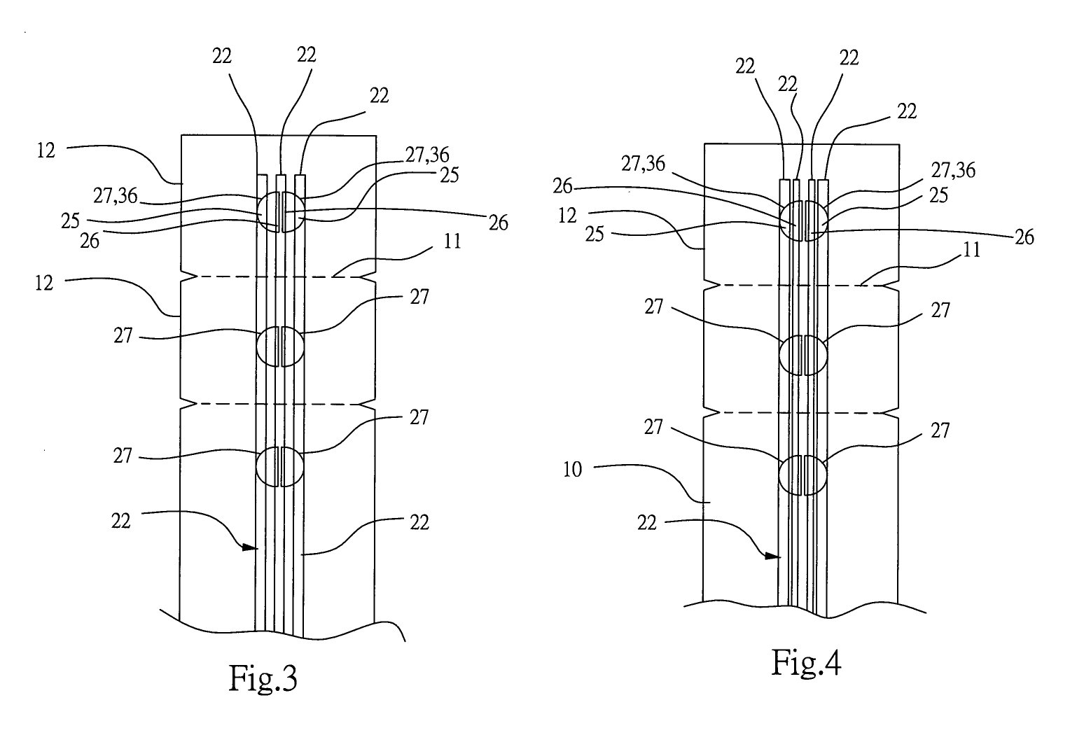

The design disclosed in FIGS. 1 and 2 involves a pair of conductive track 22 on a base plate 10. However, the design of the present invention is not limited to, but also includes a test strip for multiple tests with 3 conductive tracks 22 which measures several test data with a drop of blood. FIG. 3 shows the schematic view of the drawing of the detachable test strips for multiple tests, which gives two different test results per test simultaneously with a drop of blood. In FIG. 3, the one in the middle of the three conductive tracks 22 extends to the reference electrodes 26, while the other two conductive tracks 22 which extend to the reference electrodes 26 that form three reaction zones 27 with the working electrodes 25 on the base plate 10. Each reaction zone 27 holds two same or different reagents for two independent electrochemical reactions to occur. Each reaction zone 27 is divided into two areas in which one reagent can be applied onto the left side of the reaction zone 27 and another reagent can be applied onto the right side of the reaction zone by, say, ink jet printing. Thus, when an electric potential is applied between a pair of working and reference electrodes through the conductive tracks 22 to initiate electrochemical reaction, and, likewise, when another electrical potential is applied between the other pair of working and reference electrodes, two different electrical responses can be measured simultaneously through the three conductive tracks 22.

If one reagent applied is the same as the other, we will be measuring simultaneously, which is like repeating the same test again at the same time, both test data of the same kind and taking its average, which definitely is more accurate than doing one test alone, because, due to the inherent nature of the electrochemical reaction processes, no matter how accurate the device is, the test data fluctuate above and below the average. However, if both reagents are different, we will be measuring simultaneously two different results with a drop of blood. This is very convenient and welcome by the patients who otherwise would suffer more blood inoculation on, say, fingertips in order to test other types of analytes. Therefore, this test strip proposed in FIG. 3 can produce 6 test data on a single test strip, requiring 3 drops of blood which gives two simultaneous test data per test with a drop of blood.

To perform the same function as that of the design in FIG. 3, FIG. 4 further discloses an alternative design of a detachable test strip with four conductive tracks 22, good for three tests per strip, with two test data per test from a drop of blood. Contrary to the design in FIG. 3 which shares the same reference electrode 26 for both working electrodes 25, the design in FIG. 4 of the present invention uses a pair of working and reference electrodes 25 and 26 to measure the electrochemical response of one reagent and another pair of working and reference electrodes 25 and 26 to measure the electrochemical response of another reagent. As a result, the test strip disclosed in FIG. 4 can as well produce 6 test data from a single test strip, requiring 3 drops of blood which gives two simultaneous test data per test with a drop of blood. Similar to the design shown in FIG. 1 and FIG. 2, the base plate 10 of the design in FIGS. 3 and 4, on which lay four conductive tracks, may be covered with a spacer plate, with two or more than two recesses to accommodate reaction zones for reagents, and on top of which a top plate so that blood can be sucked into the reaction zones in the recesses to react with the reagents therein. Pressure sensitive tapes or hot melt glue, not shown, are used to adhere the base plates with the spacer plates. The pressure sensitive tapes or hot melt glue used are so configured to leave multiple air venting passages between the spacer layer and the base plates to avoid air pressure buildup as the blood or body fluid is sucked into the recess through capillary forces to react with the reagent therein.

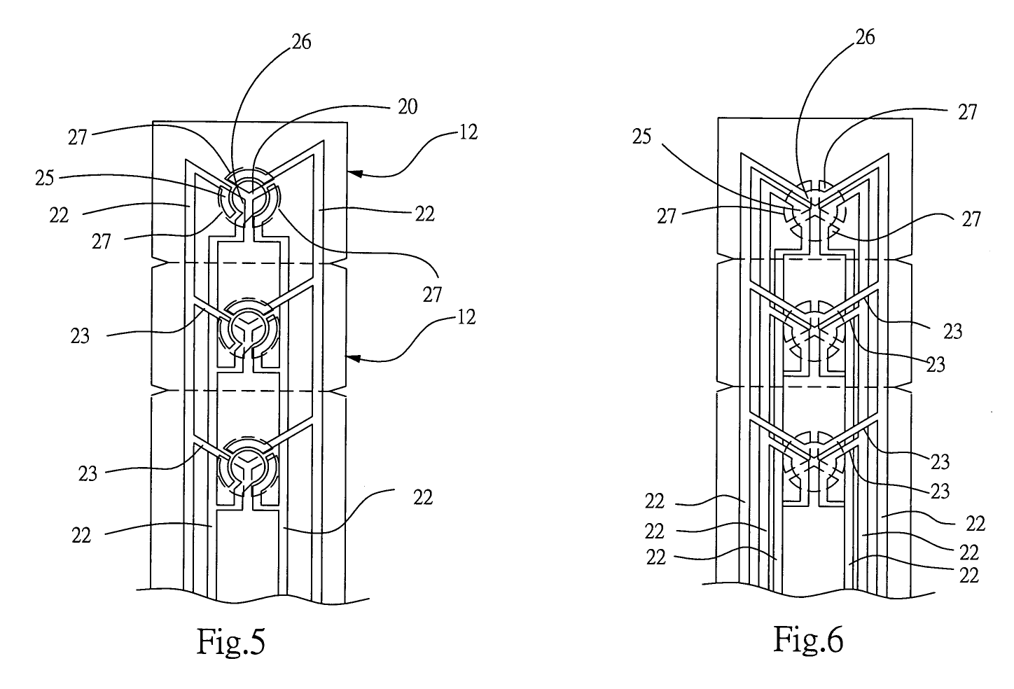

In order to simultaneously perform three measurements on one test strip for three times, there are two different types of layouts of conductive tracks 22, as shown in FIG. 5 with four conductive tracks 22 (three conductive tracks 22 extending to working electrodes 25 and a conductive track 22 extending to reference electrode 26), and as shown in FIG. 6 with six conductive tracks 22 (three conductive tracks 22 extending to working electrodes 25 and three conductive tracks 22 extending to reference electrodes 26). In FIG. 5, all four conductive tracks 22 have three branches 23, wherein the three branches 23 of the second left conductive tracks 22 leads to a circular area which serves as the reference electrode 26 for the three working electrodes 25 which further extend to the branches 23 of the other three conductive tracks 22. A wedge shaped reaction zone 27 covers across the working electrode 25 and approximately one third the reference electrode 26. There are three reaction zones 27 on a section 12 and there are three sections on a base plate 10. Insulation is required to separate the branches 23 from the conductive tracks 22 at the four intersections. With the design disclosed in the FIG. 5, the base plate (test strip) can perform 3 individual test measurements from the reaction zones 27 of the section 12 at the same time with a drop of blood, or a total of 9 measurements from the three reaction zones 27 of the three sections 12 of the base plate 10 with three drops of blood. Similar to the proposed design shown in FIG. 3 and FIG. 4, the reagents 36 applied onto the reaction zone 27 can also either be the same as or different from each other. If all three reagents are of the same type, the test procedures is like repeating the same test again and again at the same time, and taking all test data of the same kind to determine its average, which definitely is more accurate than otherwise doing one test alone or two tests at the same time, because, as stated before, due to the inherent nature of the electrochemical reaction processes, no matter how accurate the device is, the test data usually fluctuate above and below the average. However, if the three reagents are different from the each other, we will be measuring simultaneously three different test data with a drop of blood. Therefore, this test strip proposed in FIG. 5 can produce 9 test data on a single test strip, requiring 3 drops of blood.

Functionally similar to FIG. 5, FIG. 6 further shows the schematic view of yet another type of detachable test strip for multiple tests with six conductive tracks 22 (three conductive tracks 22 extending to working electrodes 25 and three conductive tracks 22 extending to reference electrodes 26). In FIG. 6, all six conductive tracks 22 have three branches 23 which extend to the reference electrodes 26 or working electrodes 25 in the reaction zones 27. A reaction zone 27 is formed on the neighboring working and reference electrodes 25 and 26 which extend to the branches 23 of the conductive tracks 22. There are three reaction zones 27 on each of the three sections 12 of the base plate 10, totaling 9 reaction zones 27 on a base plate 10, good for 9 tests. An electrical potential is applied onto the reagents 36 on the reaction zones 27 over the neighboring working and reference electrodes 25 and 26. The electrical response from the electrochemical reaction is measured to determine the concentration of the analyte in blood. The branches 23 may intersect with the conductive tracks 22 but they are insulated from each other through an insulation layer. Thus the design in FIG. 6 can simultaneously measure 3 test data, whether they are of the same type or not, with a drop of blood on the reaction zones 27 of every section 12 of the base plate 10.

Similar to the designs shown in FIG. 1, FIG. 2, FIG. 3, and FIG. 4, the base plate 10 of the design in FIGS. 5 and 6, on which lay a number of conductive tracks 22, may be covered with a spacer plate (not shown), with two or more than two recesses 14 to accommodate reaction zones for reagents, and on top of which a top plate so that blood can be sucked into the said reaction zones in the recesses to react with the reagents therein. Pressure sensitive tapes or hot melt glue, not shown, are used to adhere the base plates with the spacer plates. The pressure sensitive tapes or hot melt glue used are so configured to leave multiple air venting passages between the spacer plates and the base plates to avoid air pressure buildup as the blood or body fluid is sucked into the recess through capillary forces to react with the reagent therein.

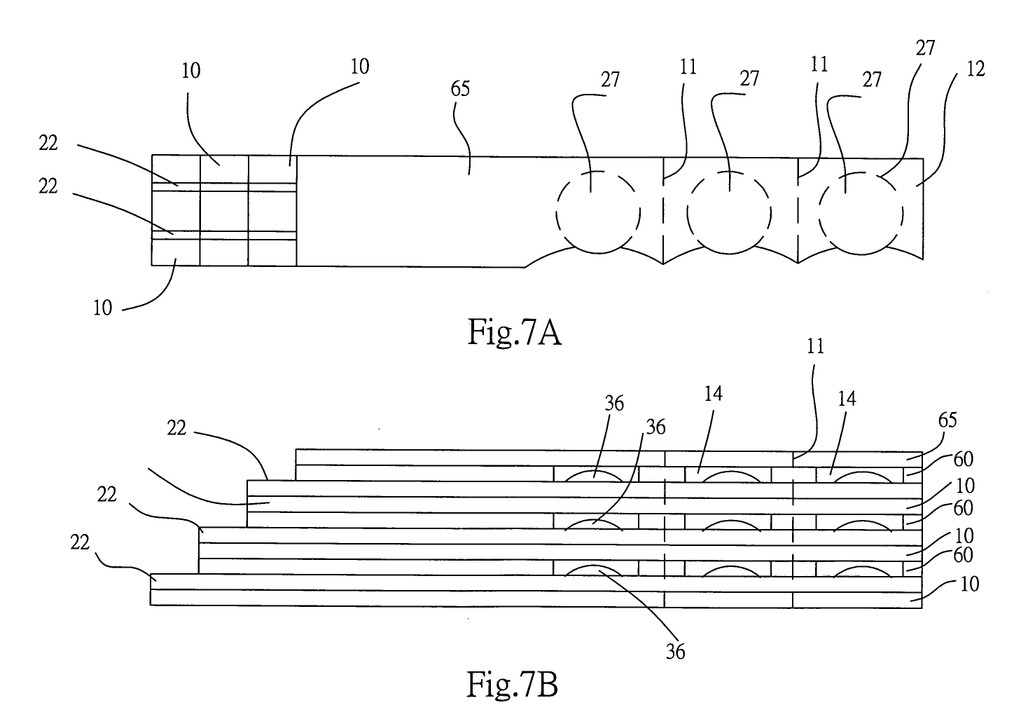

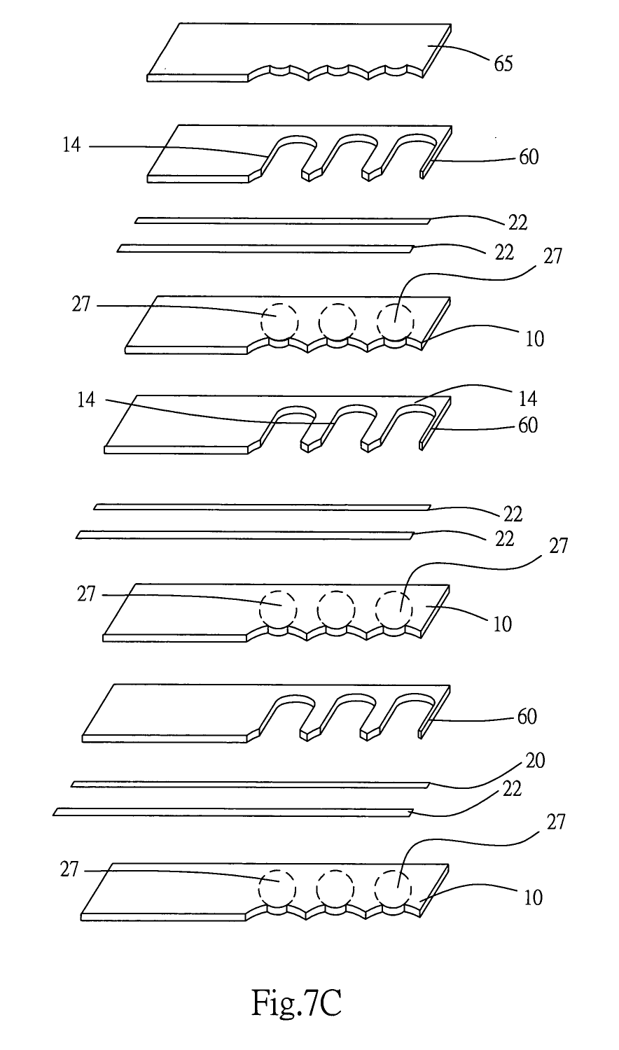

To give more insight into the structural design of the test strip for multiple tests, FIGS. 7A, 7B and 7C further give the top, side and exploded views of another type of detachable test strips for multiple tests. In FIG. 7A, FIG. 7B and FIG. 7C, a pair of conductive tracks 22 lay on the base plate 10, on top of which covers a spacer plate 60 that has three recesses 14 to accommodate reaction zones 27 for reagents 36 that sit over the conductive tracks 22. On top of the spacer plate 60 lays another base plate 10, on which lays a pair of conductive tracks 22. Further on top of the conductive tracks 22 covers another spacer plate 60 that has three recesses 14. Furthermore, on top of this spacer plate 60 lies yet another base plate 10, which lays a pair of conductive tracks 22, on top of which covers a spacer plate 60 that has three recesses 14 to accommodate three reagents 36 on the three reaction zones 27. Moreover, on top of this spacer plate 60 lays a top plate 65, which covers this spacer plate 60 that has three recesses 14. All the base plates 10, have incisions 11 to assist easier breaking off the sections 12 with reaction zone 27 after tests. To perform tests on this type of test strip, a drop of blood can be sucked into the three reaction zones 27, in the recesses 14, overlapping each other, by capillary forces to react electrochemically with the reagents therein. 3 individual electrical response of the electrochemical reaction in the recesses 14 can be measured from the three pair of conductive tracks 22 The reagents 36 on the reaction zones 27 within the recesses 14 overlapping each other may be the same as or different from each other. If they are of the same type of reagents, we will be measuring three same tests at the same time to determine their average, which apparently will be more accurate than having one test data alone or taking the average out of two test data. However, If the reagents on the reaction zones are of different types, we will be measuring three different test data at the same time with a drop of blood, which is very advantageous to the patients who, otherwise, will suffer the painful processes of multiple blood inoculation.

What is claimed is:

1. A detachable test strip for multiple tests with a pair of conductive tracks to measure from an analyte a test result per test, comprising of:
a) a base plate having multiple sections with incisions between said sections wherein said incision being under and on the sides of said base plate, and said base plate being made of ordinary plastics, FRP (fiberglass reinforced plastics), paper, or ceramics, and
b) a pair of conductive tracks laid on said base plate to form on every said section a reaction zone across the working and reference electrodes along said conductive tracks, and said conductive tracks being made of conductive polymer, silver, carbon, copper, platinum, gold, carbon on copper, carbon on conductive polymer, carbon on silver, carbon on copper, carbon on platinum, or carbon on gold, and
c) reagents which include glucose oxidase and mediator, deposited on said reaction zones of said base plate.

2. A detachable test strip for multiple tests with three conductive tracks to measure from an analyte two test data per test, comprising of:
a) a base plate having multiple sections with incisions between said sections wherein said incision being under and on the sides of said base plate, and said base plate being made of ordinary plastics, FRP (fiberglass reinforced plastics), paper, or ceramics, and
b) three conductive tracks laid on said base plate to form on every said section two reaction zones across the working and reference electrodes along said conductive tracks, and said conductive tracks being made of conductive polymer, silver, carbon, copper, platinum, gold, carbon on copper, carbon on conductive polymer, carbon on silver, carbon on copper, carbon on platinum, or carbon on gold, and
c) reagents which include glucose oxidase and mediator, deposited on said reaction zones of said base plate.

3. A detachable test strip for multiple tests with four conductive tracks to simultaneously measure two test data per test with a drop of blood, comprising of:
a) a base plate having multiple sections with incisions between said sections wherein said incision being under and on the sides of said base plate, and said base plate being made of ordinary plastics, FRP (fiberglass reinforced plastics), paper, or ceramics, and
b) four conductive tracks laid on said base plate to form on every said section two reaction zones across the working and reference electrodes along said conductive tracks, and said conductive tracks being made of conductive polymer, silver, carbon, copper, platinum, gold, carbon on copper, carbon on conductive polymer, carbon on silver, carbon on copper, carbon on platinum, or carbon on gold, and
c) reagents which include glucose oxidase and mediator, deposited on said reaction zones of said base plate.

4. A detachable test strip for multiple tests with four conductive tracks to simultaneously measure three test data with a drop of blood, comprising of:
a) a base plate having multiple sections with incisions between said sections wherein said incision being under and on the sides of said base plate, and said base plate being made of ordinary plastics, FRP (fiberglass reinforced plastics), paper, or ceramics, and
b) four conductive tracks laid on said base plate to form on every said section three reaction zones across the working and reference electrodes along said conductive tracks, wherein said conductive tracks includes three said conductive tracks having branches extending to said working electrodes and one conductive track having said branches extending to said reference electrodes, and said conductive tracks being made of conductive polymer, silver, carbon, copper, platinum, gold, carbon on copper, carbon on conductive polymer, carbon on silver, carbon on copper, carbon on platinum, or carbon on gold, and
c) reagents which include glucose oxidase and mediator, deposited on said reaction zones of said base plate.

5. A detachable test strip for multiple tests with six conductive tracks to simultaneously measure three test data with a drop of blood, comprising of:
a) a base plate having multiple sections with incisions between said sections wherein said incision being under and on the sides of said base plate, and said base plate being made of ordinary plastics, FRP (fiberglass reinforced plastics), paper, or ceramics, and
b) six conductive tracks laid on said base plate to form on every said section three reaction zones across the working and reference electrodes along said conductive tracks, wherein said conductive tracks includes three said conductive tracks having branches extending to said working electrodes and three conductive tracks having said branches extending to said reference electrodes, and said branches and said conductive electrode having insulation layer at intersection, and said conductive tracks being made of conductive polymer, silver, carbon, copper, platinum, gold, carbon on copper, carbon on conductive polymer, carbon on silver, carbon on copper, carbon on platinum, or carbon on gold, and
c) reagents which include glucose oxidase and mediator, deposited on said reaction zones of said base plate.

6. The detachable test strip for multiple tests of claim 1 to claim 5, wherein the said base plate and the said conductive tracks are covered with a spacer plate, with multiple recesses, and a top plate.

7. A detachable test strip for multiple tests with a pair of conductive electrodes to measure three test results with a drop of blood, comprising of:
a) three base plates having multiple sections with incisions between said sections wherein said incision being under and on the sides of said base plate, and said base plate being made of ordinary plastics, FRP (fiberglass reinforced plastics), paper, or ceramics, and
b) three pairs of conductive tracks laid on said base plates to form on every said section a reaction zone across the working and reference electrodes along said conductive tracks, and said conductive tracks being made of conductive polymer, silver, carbon, copper, platinum, gold, carbon on copper, carbon on conductive polymer, carbon on silver, carbon on copper, carbon on platinum, or carbon on gold, and
c) three spacer plates having multiple sections with incisions between said sections wherein said incision being under and on the sides of said base plate, and said spacer plates having recesses in every said section and, said spacer plates being formed between over said base plates and said conductive tracks, and said spacer plates being made of ordinary plastics, FRP (fiberglass reinforced plastics), paper, or ceramics, and
d) a top plate to place over the third pair of said conductive tracks, and said top plate being made of ordinary plastics, FRP (fiberglass reinforced plastics), paper, or ceramics, and
e) reagents which include glucose oxidase and mediator, deposited on said reaction zones of said base plate.
